(19) United States
(12) Patent Application Publication
(10) Pub. No.: US 2024/0370878 A1
(43) Pub. Date: Nov. 7, 2024

(54) INCIDENT ROOT CAUSE ANALYSIS SERVICE

(71) Applicant: ServiceNow, Inc., Santa Clara, CA (US)

(72) Inventors: Matthew D. Lloyd, Droitwich (GB); Sheeba Srinivasan, Atlanta, GA (US); Sonia M. Gandhi, Bengaluru (IN); Soumya Mitra, Hyderabad (IN); Nakul Kapadia, Hyderabad (IN); Nirupam Biswas, Hyderabad (IN); Spriha Utakarsha, Hyderabad (IN); Diana Zhan Shum, Temple City, CA (US); Jessica Quittner, Hollister, CA (US); Allison A. Endo, San Diego, CA (US); Lingzhu Li, Mountain View, CA (US); Tara L. Jensen, Santee, CA (US); Cary Evans, Encinitas, CA (US); Jayasri Nagrale, Hyderabad (IN)

(21) Appl. No.: 18/143,530

(22) Filed: May 4, 2023

(51) Int. Cl. G06Q 30/015; G06F 11/07

(52) U.S. Cl. CPC G06Q 30/015; G06F 11/0709; G06F 11/079

(57) ABSTRACT

A user interface is provided to manage an information technology incident. One or more candidate factors of the incident or tasks related to the incident are identified. A request to perform a root cause analysis associated with the incident is received. In response to receiving the request, at least one of the one or more candidate factors are provided as a cause and effect element of the root cause analysis via the user interface.

### BACKGROUND OF THE INVENTION

Information Technology (IT) incidents are often identified by creating a corresponding incident ticket. The incident is then assigned to a responsible party to resolve the issue. Typically, an incident resolution, such as a work around, is applied to address the incident, allowing any impacted users to continue making progress with their intended tasks. In many scenarios, the corresponding cause of the incident may still exist, allowing the incident to reappear particularly for other users.

### BRIEF DESCRIPTION OF THE DRAWINGS

Various embodiments of the invention are disclosed in the following detailed description and the accompanying drawings.

FIG. 1 is a block diagram illustrating an example of a network environment for an incident root cause analysis platform and service.

FIG. 2 is a block diagram illustrating an embodiment for implementing an incident resolution service.

FIG. 3 is a block diagram illustrating an embodiment for implementing data stores for an incident resolution service.

FIG. 4 is a flow chart illustrating an embodiment of a process for performing root cause analysis for an incident.

FIG. 5 is a flow chart illustrating an embodiment of a process for performing incident resolution using an incident resolution workflow.

FIG. 6 is a flow chart illustrating an embodiment of a process for performing incident root cause analysis using a root cause analysis workflow.

FIG. 7 is a flow chart illustrating an embodiment of a process for creating a root cause analysis context as part of a root cause analysis workflow.

FIG. 8 is a functional diagram illustrating a programmed computer system for performing root cause analysis for an incident.

FIG. 9 is a diagram illustrating an embodiment of a user interface for performing incident resolution using an incident resolution service.

FIG. 10 is a diagram illustrating an embodiment of a user interface for initiating a root cause analysis from an incident resolution workflow.

FIG. 11 is a diagram illustrating an embodiment of a user interface for performing root cause analysis using an incident resolution service.

FIG. 12 is a diagram illustrating an embodiment of a flow diagraming user interface for performing root cause analysis using an incident resolution service.

FIG. 13 is a diagram illustrating an embodiment of a flow diagraming user interface for performing root cause analysis using an incident resolution service.

FIG. 14 is a diagram illustrating an embodiment of a flow diagraming user interface for performing root cause analysis using an incident resolution service.

FIG. 15 is a diagram illustrating an embodiment of a user interface for performing root cause analysis using an incident resolution service.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A platform and service for performing incident root cause analysis is disclosed. For example, a cloud-based service is provided that allows an Information Technology Service Management (ITSM) group to manage and resolve Information Technology (IT) incidents. For example, when an incident occurs, an incident ticket or report is created via the cloud-based service. In some embodiments, a corresponding incident record is maintained by the cloud-based service to track the progress of the incident. Once an incident is identified, a responsible party from the ITSM group can be assigned to resolve the incident. Once the incident is resolved, the incident ticket can be closed and the impacted parties should no longer be impacted and can continue with their intended tasks. As an example, a video conferencing application may have problems connecting with other users running the same application. An incident ticket is created and a service desk member is assigned to resolve the incident. The relevant instance of the video conferencing application is determined to be out of date and the resolution identified is to update the application instance to the latest version. As part of resolving the incident, the application is updated and confirmed to now work correctly. In various embodiments, the incident ticket is closed and the incident record is updated.

In many instances, when a reported incident is resolved, the incident resolution does not fully address or even identify the root cause of the incident. For example, the previous out-of-date application can be updated to resolve an impacted user's ability to use the application. However, the root cause of the incident has not been addressed. For example, the application may not have been updated to the latest version because of a configuration problem between a user client and the server responsible for automatically updating software. By not addressing the underlying root cause of the incident, repeated incidents due to the same problem can continue to occur for both the original impacted party as well as for others.

The disclosed incident root cause analysis platform and service provide an integrated workflow that allows the ITSM group to seamlessly transition from an incident workflow focused on resolving an incident to a root cause analysis workflow for analyzing and resolving the root cause of the incident. For example, as part of the incident workflow, a collaborative root cause analysis workspace is created that is automatically populated with the relevant context of the incident such as an automatically generated timeline of the incident (as well as related tasks), potential cause and effect elements related to the incident, and/or previously determined root cause analysis results, among other helpful contextual information. Additional members can be further invited to the workspace to collaborate in the root cause analysis including by automatically identifying members from previously related incident records. For example, other service members that addressed similar incidents can be invited to join the root cause analysis workflow.

In some embodiments, as part of the root cause analysis workflow, the root cause analysis service can automatically correlate related tasks (including incidents) and identify relevant factors of those related tasks to populate them as potential cause and effect elements. The root cause analysis workflow further provides an interactive user interface for creating a flow diagram describing the root cause of the incident. For example, using the provided interactive user interface, service team members can link the cause and effect elements along with any other appropriate steps or elements to visually describe the root cause of the incident as a flow diagram that starts with the sources of the incident, includes any intermediate steps, and ends with a potential solution. In some embodiments, once a root cause is described in a flow format, the root cause flow is automatically converted to a root cause analysis result. The analysis and corresponding results can be saved to a root cause analysis record, the identified solution to address the root cause can be applied, and/or a corresponding report of the root cause analysis results can be generated and shared.

In some embodiments, a user interface is provided to manage an information technology (IT) incident. For example, an incident resolution service provides a user interface for managing the resolution and root cause analysis of IT incidents. The cloud-based user interface can be accessed via a network client, such as via a web browser. In some embodiments, one or more candidate factors of the incident are identified. For example, factors that may have caused the incident are identified and tracked. In some embodiments, the factors are automatically identified by the incident resolution service and the tracking of factors includes tracking factors for the incident and identified related tasks. In some embodiments, a request is received to perform a root cause analysis associated with the incident. For example, as part of an incident resolution process, a root cause analysis workflow can be initiated from within an incident resolution workflow. This allows the root cause analysis workflow to be prepopulated with a context derived from the incident resolution. In some embodiments, the provided user interface for the incident resolution workflow and corresponding root cause analysis workflow is a workspace that guides one or more assigned root cause analysis members through the appropriate workflow actions to resolve an incident and to perform a root cause analysis on the incident. In some embodiments, in response to receiving the request, at least one of the one or more candidate factors is provided as a cause and effect element of the root cause analysis via the user interface. For example, as part of the root cause analysis workflow, a flow diagram of the incident is generated. The flow diagram can include cause and effect elements (or nodes) describing the causes of the incident. In various embodiments, the cause and effect elements are provided as part of the user interface and a user can perform a drag action to place the appropriate cause and effect elements within a flow diagram to create a visual representation for the incident. The completed flow diagram can be automatically analyzed to provide root cause analysis results, such as a tabular view of the incident's issues, causes, effects, and root cause. In some embodiments, the completed root cause analysis includes root cause analysis results that can be published and/or shared, for example, by the incident resolution service.

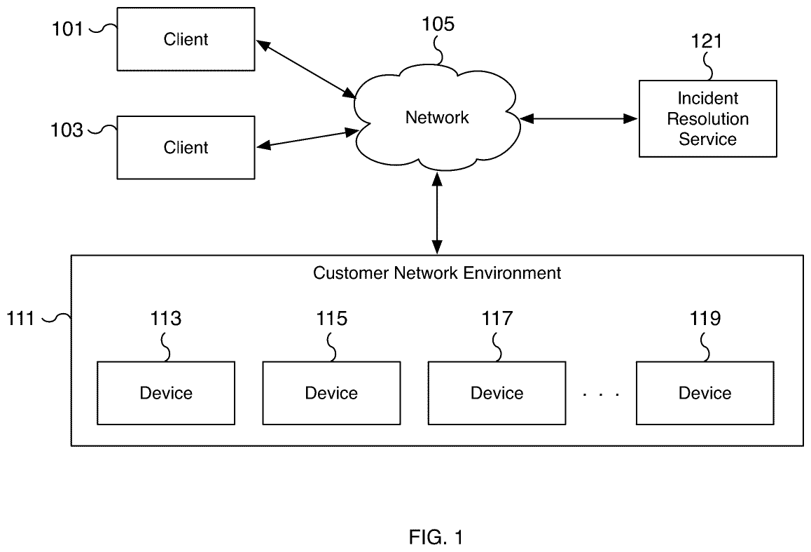

FIG. 1 is a block diagram illustrating an example of a network environment for an incident root cause analysis platform and service. In the example shown, clients 101 and 103 and incident resolution service 121 are connected via network 105. Network 105 can be a public or private network. In some embodiments, network 105 is a public network such as the Internet. In various embodiments, incident resolution service 121 is a cloud-based application server that provides for information technology service management (ITSM) that provides services for incident resolution and incident root cause analysis. For example, incident resolution service 121 provides integrated workflows for addressing incidents and their root causes. Incident resolution service 121 together with clients 101 and 103 are part of an incident root cause analysis platform for managing incidents for customer network environment 111 and specifically for devices located within customer network environment 111. For example, using the incident root cause analysis service offered by incident resolution service 121, an ITSM service member can access workflows via client 101 and/or 103 to analyze the root cause of incidents related to one or more of impacted devices of customer network environment 111. In the example shown, example devices of customer network environment 111 include devices 113, 115, 117, and 119.

In some embodiments, clients 101 and 103 are example clients for accessing incident resolution service 121. Clients 101 and 103 are each a network device such as a desktop computer, a laptop, a mobile device, a tablet, a kiosk, a voice assistant, a wearable device, or another network computing device. As network devices, clients 101 and 103 can access cloud-based services including the incident workflows provided by incident resolution service 121. For example, a member of the ITSM team can utilize a web browser or similar application from client 101 or 103 to perform ITSM actions related to incident resolution. Although shown in FIG. 1 as located outside of customer network environment 111, clients 101 and/or 103 can also be located within customer network environment 111.

In some embodiments, incident resolution service 121 offers cloud-based ITSM services including integrated workflows for addressing incidents and their root causes. In various embodiments, incidents are reported and tracked by incident resolution service 121. Further, incident resolution service 121 can provide a cloud-based workflow to resolve a reported incident, such as identifying and applying a work around, to allow impacted devices to continue functioning properly. In various embodiments, the ability to perform root cause analysis of the incident is integrated within the incident workflow. For example, as part of the incident workflow, incident resolution service 121 provides a root cause analysis service that includes a root cause analysis workflow for resolving the underlying issues that caused the incident. In various embodiments, an incident, the root cause analysis for the incident, and potential factors of the incident, among other data related to an incident are stored and tracked by incident resolution service 121. For example, incident resolution service 121 can utilize one or more different data records and one or more different data stores (not shown) to implement the root cause analysis service. In some embodiments, the root cause analysis service provides a workflow that includes automatically identifying potential factors for an incident and populating the incident context as part of the root cause analysis workflow. Relevant users helpful in analyzing the root cause can be automatically identified and invited to join the root cause analysis workflow. In various embodiments, a root cause analysis result is determined and can be used to resolve the underlying cause of the incident. In various embodiments, incident resolution service 121 can be implemented by one or more cloud-based application servers including one or more cloud-based data stores such as cloud-based application databases.

In some embodiments, customer network environment 111 is an information technology network environment and includes multiple hardware devices including devices 113, 115, 117, and 119, as examples. Devices 113, 115, 117, and 119 correspond to hardware devices that are managed by an ITSM group and each device can be one of a variety of different hardware device types including networking equipment (such as gateways and firewalls), load balancers, servers including application servers and database servers among other servers, and other computing devices including employee laptops and desktops. For example, in one scenario, devices 113, 115, 117, and 119 are each employee laptops that are experiencing technical issues that require the ITSM group to resolve in order to return to functioning properly. The incidents, their resolutions, and their corresponding root causes can be resolved via incident resolution service 121. In various embodiments, customer network environment 111 is connected to network 105. In various embodiments, the topology of customer network environment 111 can differ and the topology shown in FIG. 1 is just one simplified example.

Although single instances of some components have been shown to simplify the diagram of FIG. 1, additional instances of any of the components shown in FIG. 1 may exist. For example, incident resolution service 121 may be implemented using one or more servers such as one or more distributed application servers. In some embodiments, the implementation of incident resolution service 121 further utilizes one or more databases. Different network topologies for implementing incident resolution service 121 are appropriate and the servers and/or databases utilized by incident resolution service 121 may be replicated and/or distributed across multiple servers, databases, and/or related components. Additionally, clients 101 and 103 are example client devices for interfacing with incident resolution service 121. Although two clients are shown (clients 101 and 103), fewer or many more additional clients can exist and be used to interface with incident resolution service 121. As mentioned above, customer network environment 111 is just one example of a network environment of devices managed via incident resolution service 121. For example, in various embodiments, incident resolution service 121 can manage additional network environments not shown including different distributed environments and different sub-networks. In some embodiments, components not shown in FIG. 1 may also exist.

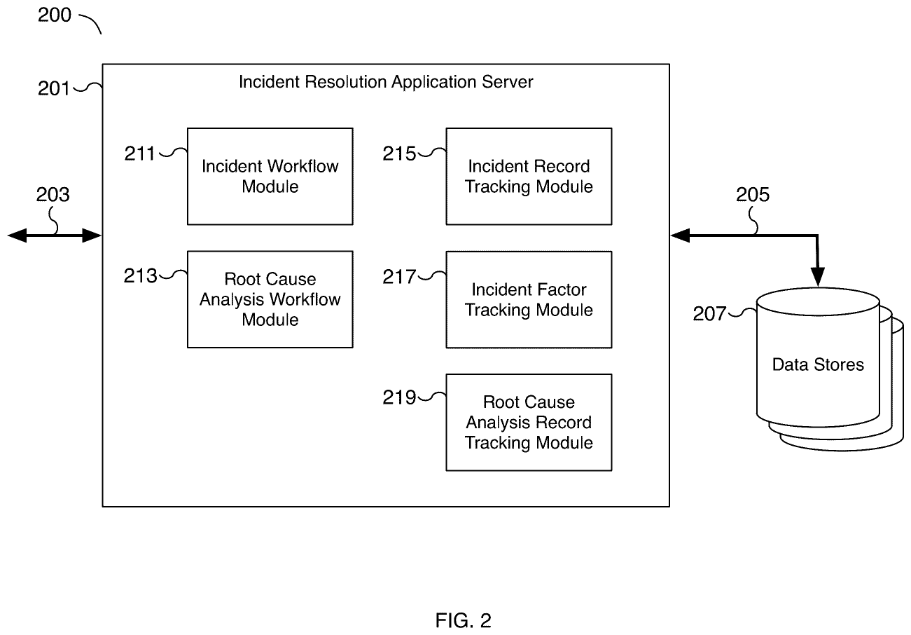

FIG. 2 is a block diagram illustrating an embodiment for implementing an incident resolution service. In the example shown, incident resolution service 200 includes incident resolution application server 201, network connection 203, database connection 205, and data stores 207. In various embodiments, the shown components and in particular incident resolution application server 201 and data stores 207 are used to implement an incident resolution service including a service for incident root cause analysis. Network connection 203 is utilized by incident resolution application server 201 to communicate with external devices including client devices. Database connection 205 is a network connection that allows incident resolution application server 201 to communicate with data stores 207. In various embodiments, incident resolution application server 201 implements the functionality for providing the incident resolution and root cause analysis services and data stores 207 is used to store and retrieve related data for the services including data records utilized by the incident resolution and root cause analysis service. In some embodiments, incident resolution service 200 is incident resolution service 121 of FIG. 1 and network connection 203 is a network connection to network 105 of FIG. 1.

In some embodiments, incident resolution application server 201 includes multiple modules for implementing the different functionality of incident resolution service 200. As shown in the example, incident resolution application server 201 includes incident workflow module 211, root cause analysis workflow module 213, incident record tracking module 215, incident factor tracking module 217, and root cause analysis record tracking module 219. Although shown as distinct modules, the functionality of the modules of incident resolution application server 201 may be implemented in fewer or more modules and/or distributed across different application servers. For example, some of the modules may be combined into a single module and/or some of the modules may be separated, replicated, and/or distributed into or as additional modules, as appropriate.

In some embodiments, incident workflow module 211 is a processing module for implementing an incident resolution workflow. For example, incidents are tracked by creating an incident ticket and a corresponding incident record. Once identified, the incident can be processed via an incident workflow. For example, the incident can be investigated and different characteristics including the incident history and factors causing the incident can be tracked and recorded. In some embodiments, the incident workflow is implemented via different workspace tabs such as an overview tab, a details tab, an investigate tab, and a related records tab. In various embodiments, each incident is assigned an individual incident identifier. The incident and its corresponding records can be stored in a data store and tracked via records such as an incident record and incident factor records. In the disclosed inventions, the incident resolution workflow seamlessly integrates with a root cause analysis workflow. For example, from within the incident resolution workflow, a service team member can initiate a corresponding root cause analysis workflow that is automatically populated with the relevant incident context. In various embodiments, the root cause analysis workflow is implemented using root cause analysis workflow module 213.

In some embodiments, root cause analysis workflow module 213 is a processing module for implementing a root cause analysis workflow. For example, root cause analysis workflow module 213 can provide a root cause analysis workflow with a root cause analysis workspace that is automatically populated with the appropriate context for the relevant incident and related tasks. In some embodiments, the automatically populated context includes potential factors causing the incident, the history of the incident, previously determined root cause analysis results, and/or other relevant details of the incident and its context. For example, potential factors causing the incident can be imported into the workspace as cause and effect elements related to the incident and used to create a flow diagram of the incident's root cause. In some embodiments, an automatically generated timeline of the incident is created that allows the service team members to visually inspect the history of the incident.

In various embodiments, root cause analysis workflow module 213 is used to create a collaborative root cause analysis workflow. For example, members can be automatically identified and invited to the workspace to collaborate in the root cause analysis including by automatically identifying members from previously related incident records or tasks. In some embodiments, other service members that addressed or experienced similar incidents can be invited to join the root cause analysis workflow.

In some embodiments, root cause analysis workflow module 213 is used to automatically correlate related incidents and identify relevant factors of those incidents to populate them as potential cause and effect elements. The root cause analysis workflow further provides an interactive user interface for creating a flow diagram describing the root cause of the incident. For example, using the provided interactive user interface, service team members can link the cause and effect elements along with any other appropriate steps or elements to visually describe the root cause of the incident as a flow diagram that starts with the sources of the incident, includes any intermediate steps, and ends with a potential solution. In some embodiments, once a root cause is described in a flow format, the root cause flow is automatically converted to a root cause analysis result. The analysis and corresponding results can be saved to a root cause analysis record, the identified solution to address the root cause can be applied, and/or a corresponding report of the root cause analysis results can be generated and shared.

In some embodiments, incident record tracking module 215 is used to create and manage incident data records. For example, incident record tracking module 215 can track incidents and associate incidents with related incident data fields using an incident record. Example incident data fields can include details of the incident, related incident records, related incident factor records, and a corresponding root cause analysis record. In some embodiments, each incident has an associated unique incident identifier and incident record tracking module 215 can utilize the identifier to differentiate between different incident records. In some embodiments, incident record tracking module 215 interfaces with an incident records data store such as an incident records database and one or more incident records database tables. In the example shown, the data store corresponds to one or more data stores of data stores 207.

In some embodiments, incident factor tracking module 217 is used to create and manage incident factor data records. For example, incident factor tracking module 217 can track factors related to an incident including candidate causes of the incident using one or more incident factor records. In various embodiments, the details of the incident factors can be automatically identified and/or provided from user experiences. In some embodiments, each incident factor has an associated unique incident factor identifier and incident factor tracking module 217 can utilize the identifier to differentiate between different incident factors. In some embodiments, incident factor tracking module 217 interfaces with an incident factors data store such as an incident factors database and one or more incident factors database tables. In the example shown, the data store corresponds to one or more data stores of data stores 207.

In some embodiments, root cause analysis record tracking module 219 is used to create and manage root cause analysis data records. For example, root cause analysis record tracking module 219 can track the progress and results of performing a root cause analysis on an incident using a root cause analysis data record. In various embodiments, a root cause analysis data record can include details of the associated incident, a timeline and/or set of time-based events of the incident and related tasks, the team members associated and/or assigned to the root cause analysis, a flow diagram and associated steps for the root cause analysis, the progress or status of the root cause analysis, root cause analysis results, and/or related root cause analysis results, among other related data. In some embodiments, each root cause analysis workflow has an associated unique root cause analysis identifier and root cause analysis record tracking module 219 can utilize the identifier to differentiate between different root cause analysis workflows. In some embodiments, root cause analysis record tracking module 219 interfaces with a root cause analysis records data store such as a root cause analysis records database and one or more root cause analysis records database tables. In the example shown, the data store corresponds to one or more data stores of data stores 207.

In some embodiments, data stores 207 is one or more data stores utilized by incident resolution application server 201 for storing and/or retrieving data for incident analysis. For example, different data records such as incident records, incident factor records, and root cause analysis records can be stored in data stores 207. In various embodiments, data stores 207 can include one or more potentially different data stores for incident records, incident factors, and root cause analysis records. Moreover, in some embodiments, data stores 207 is implemented as one or more distributed and/or replicated databases. For example, one or more portions of data stores 207 may be located at a different physical location (such as in a different data center) than incident resolution application server 201. In various embodiments, data stores 207 is communicatively connected to incident resolution application server 201 via database connection 205. In some embodiments, database connection 205 is implemented via one or more different network connections, as needed.

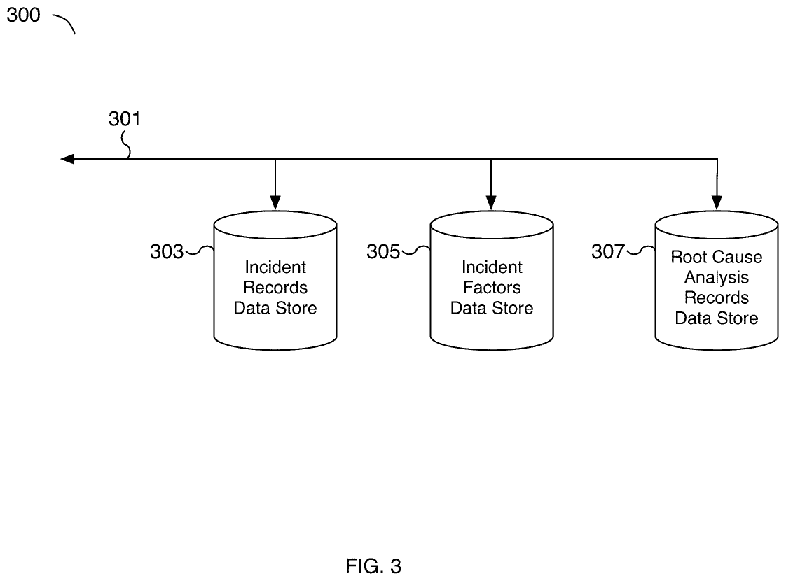

FIG. 3 is a block diagram illustrating an embodiment for implementing data stores for an incident resolution service. In various embodiments, data stores 300 is utilized by one or more incident resolution application servers for implementing an incident resolution service. As shown in the example, data stores 300 includes database connections 301, incident records data store 303, incident factors data store 305, and root cause analysis records data store 307. Database connections 301 represents one or more network connections for communicatively connecting incident records data store 303, incident factors data store 305, and root cause analysis records data store 307 to an incident resolution application server and/or to one another. In some embodiments, database connections 301 is database connection 205 of FIG. 2 and incident records data store 303, incident factors data store 305, and root cause analysis records data store 307 are data stores 207 of FIG. 2. In some embodiments, the incident resolution application server connected to data stores 300 via database connections 301 is incident resolution application server 201 of FIG. 2. In some embodiments, data stores 300 is used to implement incident resolution service 121 of FIG. 1 and/or incident resolution service 200 of FIG. 2.

In some embodiments, incident records data store 303 is a data store for storing and retrieving incident and related data records. Incident records data store 303 can be one or more databases including distributed databases. In some embodiments, incident records data store 303 is implemented as one or more incident database tables. The stored records including incident data records can include details of an incident including a context, a description, a user responsible for resolving the incident, references to potential factors causing the incident, and/or a reference to a root cause analysis record, among other relevant details. In some embodiments, incident records data store 303 may utilize a unique incident identifier or key as a database record identifier to differentiate between different incidents.

In some embodiments, incident factors data store 305 is a data store for storing and retrieving incident factor and related data records. Incident factors data store 305 can be one or more databases including distributed databases. In some embodiments, incident factors data store 305 is implemented as one or more incident factors database tables. The stored records including incident factor data records can include details of factors related to an incident including a context, a description, and/or a user responsible for providing the description of the factors, among other relevant details. In some embodiments, incident factors data store 305 may utilize a unique factor identifier or key as a database record identifier to differentiate between different potential factors for a root cause of an incident.

In some embodiments, root cause analysis records data store 307 is a data store for storing and retrieving root cause analysis and related data records. Root cause analysis records data store 307 can be one or more databases including distributed databases. In some embodiments, root cause analysis records data store 307 is implemented as one or more root cause analysis database tables. The stored records including root cause analysis data records can include root cause analysis details for an incident including details of the associated incident, a timeline and/or set of time-based events of the incident and related tasks, the team members associated and/or assigned to the root cause analysis, a flow diagram and associated steps for the root cause analysis, the progress or status of the root cause analysis, root cause analysis results, and/or related root cause analysis results, among other relevant data. In some embodiments, root cause analysis records data store 307 may utilize a unique root cause analysis identifier or key as a database record identifier to differentiate between different root cause analysis records and workflows.

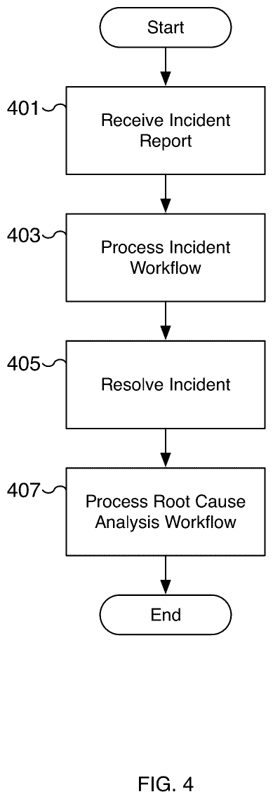

FIG. 4 is a flow chart illustrating an embodiment of a process for performing root cause analysis for an incident. In some embodiments, the root cause analysis is offered as a workflow service integrated with an incident resolution workflow. For example, a root cause analysis workflow is seamlessly integrated as part of an incident workflow process. In various embodiments, the root cause analysis workflow is offered as part of an Information Technology Service Management (ITSM) service. In some embodiments, the process of FIG. 4 is performed by an incident resolution service such as incident resolution service 121 of FIG. 1 and/or incident resolution service 200 of FIG. 2. In some embodiments, the data stores utilized by the incident resolution service are data stores 207 of FIG. 2 and/or data stores 300 of FIG. 3. In some embodiments, the process of FIG. 4 is accessed via a client such as client 101 and/or 103 of FIG. 1 to manage incidents experienced by devices such as devices 113, 115, 117, and/or 119 of FIG. 1.

At 401, an incident report is received. For example, a user or service member creates an incident report such as one associated with a corporate device under the management of an ITSM group. The incident report can describe the incident and the impacted devices. In various embodiments, the created incident report results in the creation of an incident record along with a unique identifier for the reported incident.

At 403, an incident workflow is processed. For example, an incident workflow is provided as a service and allows an assigned ITSM service team member to investigate and resolve incidents experienced by devices under the management of the ITSM team. In some embodiments, the workflow provides a workspace environment that includes details of the workflow such as the context of the workflow and factors related to the incident including potential causes of the incident. As part of the workflow process, the incident can be assigned to a designed ITSM service member for resolution. For example, the candidate factors of and potential resolutions for the incident can be automatically identified and are provided within the incident workspace that is accessible by the responsible ITSM service member. In some embodiments, the incident along with its progress is tracked via an incident record. In various embodiments, the incident is closed when a resolution is identified and applied.

At 405, the incident is resolved. For example, using the process workflow provided at 403, the incident is resolved, for example, by applying an identified resolution. The applied resolution, such as a work around, can be applied to resolve the incident that allows the impacted devices to continue to function properly (and/or allow their impacted users to continue working) but may not address the underlying cause of the incident. For example, a resolution can involve updating an impacted software application and confirming that the updated software application is properly configured but does not address what caused the software to become out of date. As another example, a resolution can involve replacing a defective memory unit in a laptop device but does not address the potential environmental conditions that caused the memory to become defective. In various embodiments, once an incident is resolved, the ability to access a root cause analysis workflow is provided within the incident workflow. For example, a user interface dialog allows the assigned ITSM service member to seamlessly initiate a root cause analysis for the resolved incident from within the incident resolution workspace. In various embodiments, the progress and/or state of the incident is tracked such as by using the incident record.

At 407, a root cause analysis workflow is processed. For example, a root cause analysis workflow offered as an ITSM service is initiated from within an incident resolution workflow. In various embodiments, the root cause analysis workflow includes the creation of a root cause analysis workspace that is prepopulated with the context of the incident including details of the incident and members assigned to contribute to the root cause analysis. For example, potential factors of the incident are automatically identified and are prepopulated into the root cause analysis workspace as cause and effect elements. As another example, members that can contribute to the root cause analysis can be automatically invited to collaborate in the root cause analysis. Similarly, a history of the incident including a list of incident events and a history of previous root cause analysis results is provided within the root cause analysis workspace as part of the root cause analysis workflow. In some embodiments, the workflow can include the creation of a root cause analysis record along with a unique identifier for the root cause analysis. Using the provided workspace and as part of the root cause analysis workflow, a flow diagram describing the root cause of the incident can be created, for example, by utilizing the automatically populated cause and effect elements and any additional provided steps. Using the generated flow diagram, a root cause analysis result can be created that describes the cause of the incident and a resolution. In some embodiments, the progress and/or state of the root cause analysis is tracked such as by using a root cause analysis record. As part of the root cause analysis workflow, the resolution for the root cause can be applied and/or a report of the root cause can be generated and shared.

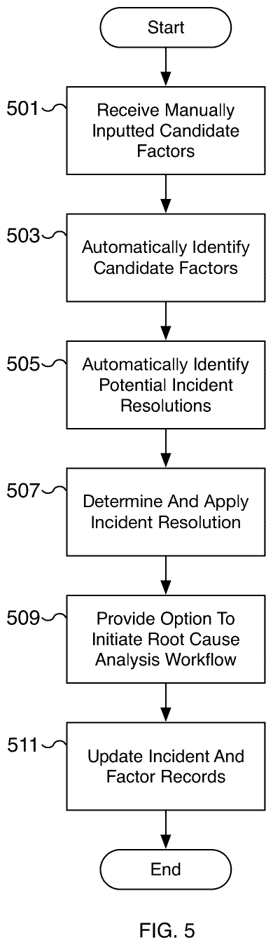

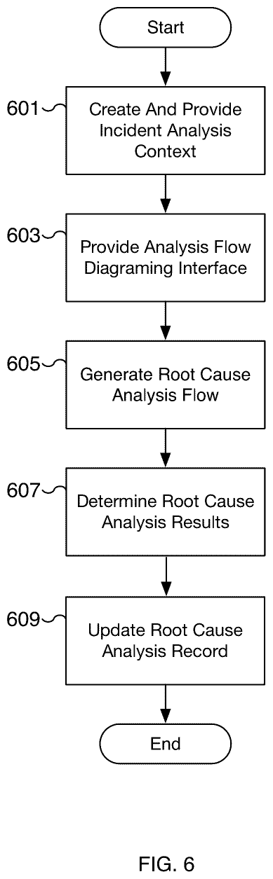

FIG. 5 is a flow chart illustrating an embodiment of a process for performing incident resolution using an incident resolution workflow. In some embodiments, the incident resolution workflow is offered as part of an Information Technology Service Management (ITSM) service for managing devices by an ITSM group that seamlessly integrates a root cause analysis workflow. In some embodiments, the process of FIG. 5 is performed by an incident resolution service such as incident resolution service 121 of FIG. 1 and/or incident resolution service 200 of FIG. 2 at 403 and/or 405 of FIG. 4. In some embodiments, the data stores utilized by the incident resolution service are data stores 207 of FIG. 2 and/or data stores 300 of FIG. 3. In some embodiments, the incident resolution workflow of FIG. 5 is accessed via a client such as client 101 and/or 103 of FIG. 1 to manage incidents experienced by devices such as devices 113, 115, 117, and/or 119 of FIG. 1. In some embodiments, the associated root cause analysis workflow is described with respect to FIG. 6.

At 501, manually inputted candidate factors for the incident are received. For example, an ITSM service member assigned to resolve the incident can manually provide factors that may have caused the incident. As another example, users that reported and/or experience the incident can manually provide details related to the incident including potential factors or causes of the incident. The submitted details can be provided with a web interface to the incident resolution service as part of the incident resolution workflow using a chat bot or virtual agent, over email, or another appropriate technique. The provided details are processed and included within the incident resolution workspace. In some embodiments, the factors are tracked using incident factor records.

At 503, candidate factors for the incident are automatically identified. For example, one or more possible factors for the incident are automatically identified by the incident resolution service including by examining related incidents and their factors. In some embodiments, the impacted devices are probed for performance data such as error logs, crash reports, performance metrics, user logs, and/or usage logs, among other data. The retrieved data is analyzed and potential factors are automatically identified and included within the incident resolution workspace. In some embodiments, the factors are tracked using incident factor records.

At 505, potential incident resolutions are automatically identified. For example, the incident and its context including its factors are analyzed by the incident resolution service and potential resolutions for the incident are automatically identified. In some embodiments, the resolutions are based on successful resolutions applied to related incidents. In some embodiments, the resolutions are based on suggested resolutions provided by vendors such as application and hardware vendors. In various embodiments, the provided potential resolutions can be associated with other incident records and references to the related incidents are provided within the incident workspace.

At 507, an incident resolution is determined and applied. For example, the service member assigned to resolve the incident selects and applies a resolution for the incident. The selected resolution can be a work around that resolves the immediate impact of the incident but does not address the root cause of the incident. In various embodiments, once an incident is resolved, the corresponding incident record is updated to reflect that status of the incident. In some embodiments, an incident report is generated to reflect the resolved incident.

At 509, an option to initiate a root cause analysis workflow is provided. For example, once an incident is resolved, an option to initiate a root cause analysis workflow is provided from within the incident workflow and incident workspace. In various embodiments, if initiated, the incident details will be used to automatically populate the root cause analysis workflow and corresponding workspace. For example, identified factors, incident events, and/or identified resolutions, among other details are used to populate the root cause analysis workflow and corresponding workspace.

At 511, incident and factor records are updated. For example, corresponding incident and incident factor records used for incident resolution and the incident resolution workflow are updated to reflect the resolved incident and the result from performing a root cause analysis of the incident. In some embodiments, the incident and incident factor records are linked (or unlinked) to the root cause analysis depending on the outcomes.

FIG. 6 is a flow chart illustrating an embodiment of a process for performing incident root cause analysis using a root cause analysis workflow. In some embodiments, the root cause analysis workflow is offered as part of an Information Technology Service Management (ITSM) service for managing devices by an ITSM group that is seamlessly integrated with and launched from an incident resolution workflow. In some embodiments, the process of FIG. 6 is performed by an incident resolution service such as incident resolution service 121 of FIG. 1 and/or incident resolution service 200 of FIG. 2 at 407 of FIG. 4. In some embodiments, the data stores utilized by the incident resolution service are data stores 207 of FIG. 2 and/or data stores 300 of FIG. 3. In some embodiments, the root cause analysis workflow of FIG. 6 is accessed via a client such as client 101 and/or 103 of FIG. 1 to manage incidents experienced by devices such as devices 113, 115, 117, and/or 119 of FIG. 1. In some embodiments, the associated incident resolution workflow is described with respect to FIG. 5.

At 601, an incident root cause analysis context is created and provided. For example, the context surrounding an incident is created and provided as part of providing the root cause analysis workflow. In some embodiments, the context is created and provided within a root cause analysis workspace, such as an interactive user interface for navigating and progressing through the root cause analysis workflow. In various embodiments, the context is created using the details of the incident used to launch the root cause analysis workflow. The included context can include a description of the incident, past and/or related root cause analysis results, a set of related incident events and/or a timeline of the incident, a list of members and/or potential members to include in the root cause analysis, and/or potential cause and effect elements of the incident, among other incident context details.

At 603, an analysis flow diagraming interface is provided. For example, an interactive flow diagraming user interface is provided that allows the assigned root cause analysis participants to create a flow diagram describing the incident and its root cause. The diagramming interface allows for the creation of a visual flow diagram illustrating the steps leading to the incident including the underlying root cause of the incident. In various embodiments, the provided flow diagraming interface allows users to interactively create the flow diagram, such as by dragging and dropping one or more cause and effect elements into a flow diagram and linking the different elements based on their relationships. The interactive cause and effect element nodes can be automatically provided by the diagraming interface based on the cause and effect elements automatically populated at 601 using factors identified as relating to the incident including potential factors that caused the incident.

At 605, a root cause analysis flow is generated. For example, using the analysis flow diagraming interface provided at 603, root cause analysis participants select and link together flow diagram nodes describing the incident as part of a process to generate a root cause flow diagram. In some embodiments, the nodes include placing cause and effect elements including automatically and manually provided cause and effect elements. The analysis participants can further insert and/or add additional steps (or nodes) to the flow diagram including a root cause step and/or a resolution step to identify the underlying root cause. For example, the root cause for a crashing software application can be generated as a flow diagram using connected nodes that include: (1) the impacted application is crashing, (2) the impacted application is out of date, (3) the impacted application was not updated automatically in quarterly patching, (4) the laptop running the impacted application was powered off for a few weeks during the laptop user's vacation, (5) the root cause of the impacted application crashing is that the application content delivery daemon did not automatically update the impacted application when the laptop was powered off.

At 607, root cause analysis results are determined. For example, using the root cause analysis flow generated at 605 along with other details of the incident, root cause analysis results can be determined. In some embodiments, the automatically determined root cause analysis results are generated by at least analyzing the generated root cause analysis flow diagram. For example, the incident creation steps including root cause steps are identified in the flow diagram generated at 605 and the flow diagram is automatically converted to root cause analysis results that include a summary and conclusion of the root cause analysis. In some embodiments, the root cause analysis results can include the causes of the incident along with fixes, preventative measures, and/or follow-up actions. In some embodiments, the root cause analysis results include why the incident happened, reasons why the cause of the incident was missed, and how the impacted device failed, among other root cause analysis results.

At 609, a root cause analysis record is updated. For example, a root cause analysis record created for the root cause analysis process of the incident is updated. In some embodiments, the record is updated and associated with related root cause analysis results as well as related incident and incident factor records. For example, incident and incident factor records used by the corresponding incident resolution workflow are associated with the root cause analysis record. In various embodiments, the root cause analysis record is used to track the progress and/or state of the root cause analysis workflow and the record is updated to reflect the steps performed during the root cause analysis of the incident.

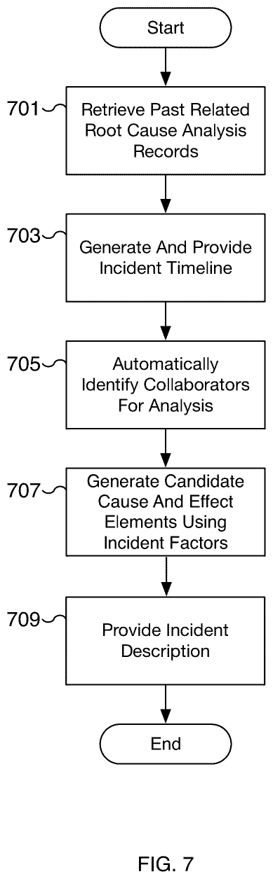

FIG. 7 is a flow chart illustrating an embodiment of a process for creating a root cause analysis context as part of a root cause analysis workflow. In some embodiments, the context is utilized as part of a root cause analysis workflow and provided within a root cause analysis workspace that is offered by an Information Technology Service Management (ITSM) service. In some embodiments, the process of FIG. 7 is performed as part of a provided root cause analysis workflow by an incident resolution service such as incident resolution service 121 of FIG. 1 and/or incident resolution service 200 of FIG. 2 at 407 of FIG. 4 and/or 601 of FIG. 6. In some embodiments, the data stores utilized by the incident resolution service are data stores 207 of FIG. 2 and/or data stores 300 of FIG. 3.

At 701, past related root cause analysis records are retrieved. For example, a history or reference to related root cause analysis records is provided in a root cause analysis workspace. For some incidents, multiple related root cause analysis records can exist, for example, such as records for one or more previously performed root cause analyses or related analyses for similar incidents. In various embodiments, the related analysis records are automatically identified and retrieved, for example, from a root cause analysis record data store. In some embodiments, the retrieved records can include published reports summarizing the previously performed root cause analyses.

At 703, an incident timeline is generated and provided. For example, a timeline of the incident is automatically generated and provided in a root cause analysis workspace. In various embodiments, the incident timeline includes the events leading up to the incident and related tasks as well as any actions taken to resolve the incident. The timeline can be presented in one or more different formats including a time-based chart or graph, and/or a table, among other formats including visual and/or text-based formats. In various embodiments, the events on the timeline are coded for ease of understanding and the events can be tagged with descriptions including relevant parties or individuals. For example, the name and/or contact information of the person that reported the incident can be included and/or revealed for an incident report event shown on the incident timeline.

At 705, collaborators for the root cause analysis are automatically identified. For example, one or more potential collaborators for the root cause analysis are automatically identified and can be invited to join the root cause analysis workflow and workspace. In some embodiments, the collaborators are identified by analyzing the incident details including incident reports and incident resolution actions. In various embodiments, the identified collaborators can be invited to join the workspace and can be shown as part of the incident description. In some embodiments, the potential collaborators are updated over time as additional progress is made on the root cause analysis including by analyzing related incident resolutions and root cause analyses for related incidents.

At 707, candidate cause and effect elements are generated using incident factors. For example, the current incident and/or related incidents and related root cause analyses are analyzed to identify candidate cause and effect elements to describe the root cause of the incident. In some embodiments, the candidate cause and effect elements are based on identified factors of the incident, such as whether a laptop was powered off, whether the laptop lost network connectivity, whether the user's credentials are expired, an update performed on the impacted software application, etc. In various embodiments, the candidate cause and effect elements are generated and shown as a list of available elements and/or as a list of available nodes that can be used to create a flow diagram (or map) of the root cause. In some embodiments, the potential cause and effect element nodes can be dragged and dropped using an interactive flow diagramming interface to generate a visual representation of the root cause of the incident. In various embodiments, the candidate cause and effect elements can include possible factors, causes, and fixes for the incident.

At 709, an incident description is provided. For example, a description of the incident is provided in a root cause analysis workspace. In some embodiments, the workspace includes one or more interactive user interface views or dialogs, each with potentially multiple sections. In some embodiments, the provided description is included in one of the user interface views and can include details on how the incident arose and/or was detected, the opening date of the incident and/or root cause analysis as well as a close date of the incident and/or root cause analysis, if applicable, among other description information. In some embodiments, the incident description includes the individuals (and/or groups) assigned to the root cause analysis. For example, any ITSM service team members invited to contribute to the workflow can be shown along with whether they have accepted an invitation to participate in the analysis. In some embodiments, the relationships and/or responsibilities of the contributors are shown, such as whether a user is a primary team member with increased responsibility, whether a user has read, write, and/or share access to the workflow, and a reference to the user's history with respect to the incident and/or root cause analysis.

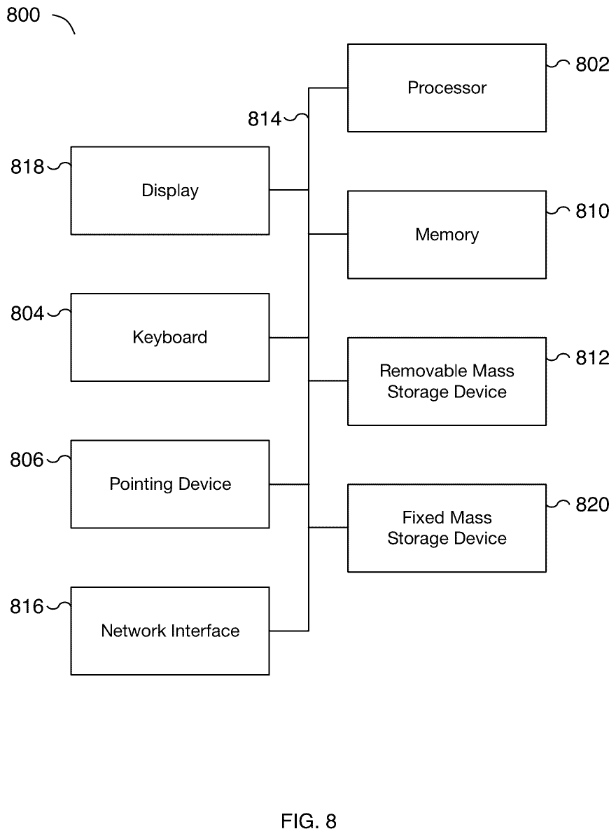

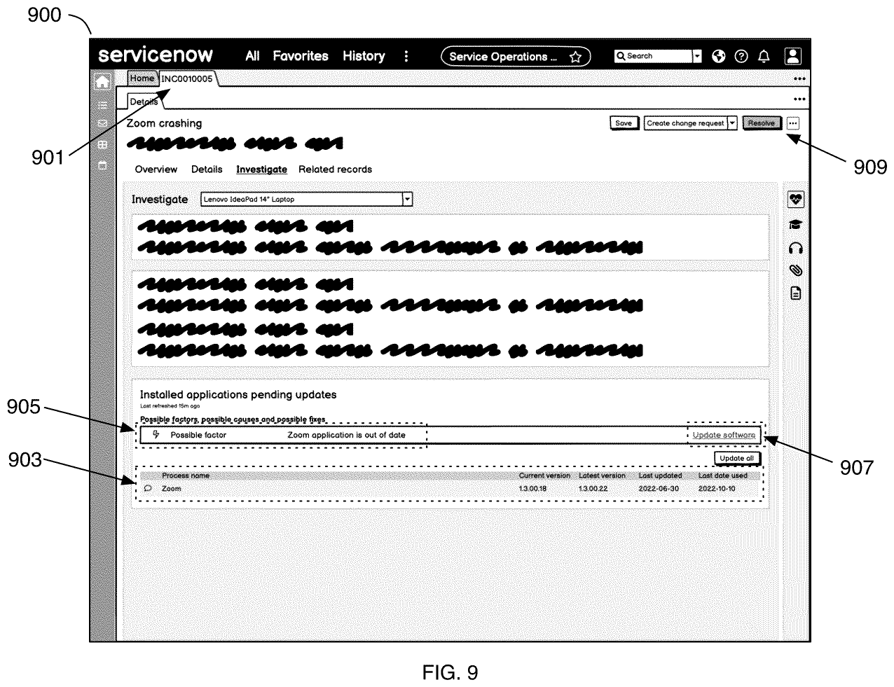

FIG. 8 is a functional diagram illustrating a programmed computer system for performing root cause analysis for an incident. As will be apparent, other computer system architectures and configurations can be utilized for performing root cause analysis for an incident. Examples of computer system 800 include clients 101 and 103 of FIG. 1, one or more computers of incident resolution service 121 of FIG. 1, one or more devices of customer network environment 111 of FIG. 1, one or more computers of incident resolution service 200 of FIG. 2, and/or one or more computers of data stores 300 of FIG. 3. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818). In various embodiments, one or more instances of computer system 800 can be used to implement at least portions of the processes of FIGS. 4-7 and one or more user interfaces of FIGS. 9-15.

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data and objects used by the processor 802 to perform its functions (e.g., programmed instructions). For example, memory 810 can include any suitable computer-readable storage media, described below, depending on whether, for example, data access needs to be bi-directional or unidirectional. For example, processor 802 can also directly and very rapidly retrieve and store frequently needed data in a cache memory (not shown).

A removable mass storage device 812 provides additional data storage capacity for the computer system 800, and is coupled either bi-directionally (read/write) or unidirectionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storages 812, 820 generally store additional programming instructions, data, and the like that typically are not in active use by the processor 802. It will be appreciated that the information retained within mass storages 812 and 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

FIG. 9 is a diagram illustrating an embodiment of a user interface for performing incident resolution using an incident resolution service. In the example shown, user interface 900 is a user interface view of an incident resolution workflow integrated with a root cause analysis workflow. In various embodiments, user interface 900 is part of an incident resolution workspace and displays user interface components to guide a user through a process to resolve an incident that includes initiating a root cause analysis of the incident. In the example shown, user interface 900 includes incident identifier 901, impacted resources dialog 903, incident factors dialog 905, incident resolution action section 907, and incident resolution button 909 to highlight certain features of user interface 900. In some embodiments, user interface 900 is provided by an incident resolution service such as incident resolution service 121 of FIG. 1 and/or incident resolution service 200 of FIG. 2. In some embodiments, user interface 900 is accessed via network clients such as clients 101 and/or 103 of FIG. 1 and is used to manage incidents related to devices such as the devices of customer network environment 111 of FIG. 1 using the processes of FIGS. 4-7.

In various embodiments, the incident being resolved using the incident resolution workspace associated with user interface 900 corresponds to a unique incident with a unique incident identifier. In the example shown, incident identifier 901 is a visual representation of the unique incident identifier and incident identifier 901 is shown on the tab of user interface 900. The relevant impacted resource of the incident is shown in impacted resources dialog 903. In the example shown, impacted resources dialog 903 displays a process name (“Zoom”) along with corresponding version information such as current version, latest version, last updated time, and last date used. Although a software application (“Zoom”) is shown in FIG. 9, other impacted resources can be displayed in impacted resources dialog 903 such as a device name, a hardware resource, an information technology workflow process, and an online service, among others. In the example shown, an interactive icon is shown in impacted resources dialog 903 to the left of the process name “Zoom.” In various embodiments, the interactive icon allows the workflow user to leave comments related to the incident including comments used to generate factors related to the incident such as possible causes and fixes.

In some embodiments, a list of candidate factors related to the incident is shown. The list of candidate or possible factors can include automatically identified and manually submitted factors. In the example shown, incident factors dialog 905 lists candidate factors including possible causes and fixes for the relevant incident. For example, one possible factor listed as an example shown in incident factors dialog 905 as a “possible factor” is “Zoom application is out of date.” In various embodiments, additional factors including causes and fixes are shown and the user can interact with the factors to add, remove, and/or prioritize the factors. As shown in user interface 900 and to the right of incident factors dialog 905 is incident resolution action section 907. The text “Update software” is a description shown in incident resolution action section 907 and corresponds to an interactive button that allows the user to apply the described action to resolve the incident. In the example shown, the incident resolution is associated with a factor of incident factors dialog 905.

In various embodiments, the state of an incident is open until it is resolved. Once an incident is resolved, a root cause analysis workflow can be initiated from the incident workflow. In the example shown, user interface 900 includes incident resolution button 909 that allows a user to mark the incident as resolved. In various embodiments, selecting incident resolution button 909 to resolve an incident will allow user interface 900 to transition to include the ability to initiate a root cause analysis workflow using the existing resolved incident as context.

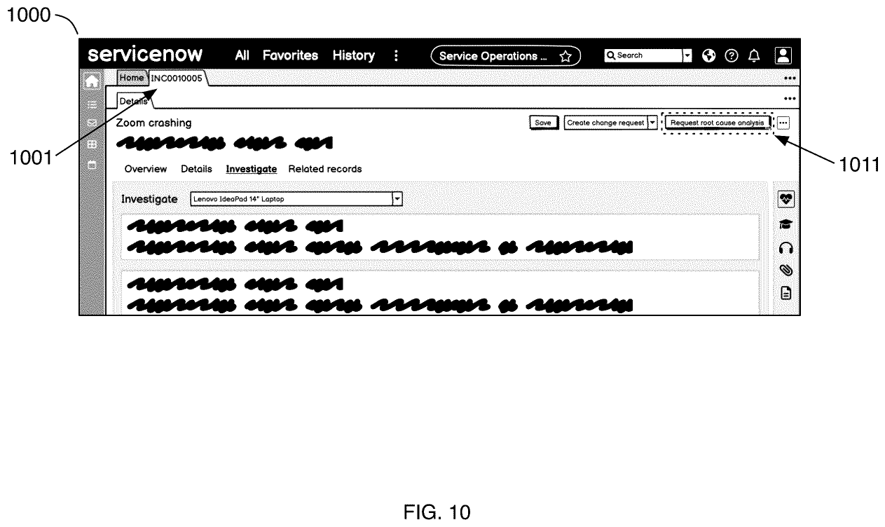

FIG. 10 is a diagram illustrating an embodiment of a user interface for initiating a root cause analysis from an incident resolution workflow. In various embodiments, user interface 1000 is part of an incident resolution workspace and displays user interface components to guide a user through a process to resolve an incident that includes initiating a root cause analysis of the incident. In the example shown, user interface 1000 is a user interface view 900 of FIG. 9 after the incident has been resolved and after selecting incident resolution button 909 of FIG. 9. As shown in FIG. 10, user interface 1000 includes incident identifier 1001 matching incident identifier 901 of FIG. 9 and request root cause analysis button 1011 to highlight certain of the features of user interface 1000. In various embodiments, once an incident progresses to a resolved state, for example, by selecting incident resolution button 909 of FIG. 9, request root cause analysis button 1011 replaces the incident resolution button in the incident resolution workspace. In various embodiments, request root cause analysis button 1011 initiates a root cause analysis workflow using the existing resolved incident as context. In some embodiments, user interface 1000 is provided by an incident resolution service such as incident resolution service 121 of FIG. 1 and/or incident resolution service 200 of FIG. 2. In some embodiments, user interface 1000 is accessed via network clients such as clients 101 and/or 103 of FIG. 1 and is used to manage incidents related to devices such as the devices of customer network environment 111 of FIG. 1 using the processes of FIGS. 4-7.

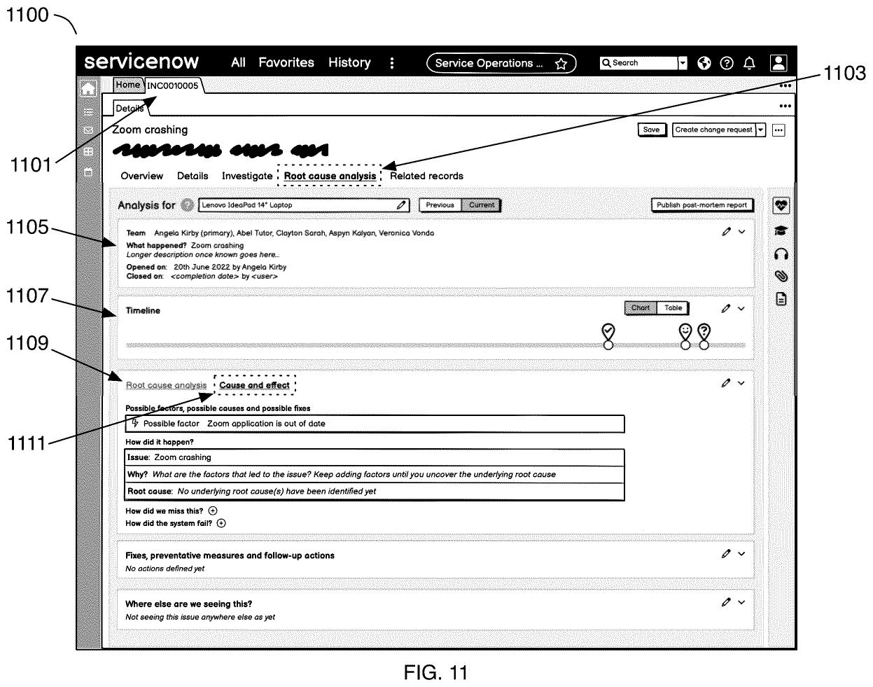

FIG. 11 is a diagram illustrating an embodiment of a user interface for performing root cause analysis using an incident resolution service. In various embodiments, user interface 1100 is part of a root cause analysis workspace and displays user interface components to guide a user through a process to analyze the root cause of an incident. In the example shown, user interface 1100 is a user interface view of a root cause analysis workflow initiated from an incident resolution workflow. For example, user interface 1100 can be initiated from the incident resolution workflow of user interface 1000 of FIG. 10 by selecting request root cause analysis button 1011 of FIG. 10. In the example shown, user interface 1100 includes multiple root cause analysis workspace sections with incident and root cause analysis information including the labeled sections incident identifier 1101, root cause analysis selection label 1103, root cause analysis description section 1105, root cause analysis timeline section 1107, root cause analysis details section 1109, and root cause analysis flow diagraming view selection label 1111 to highlight certain of the features of user interface 1100. In some embodiments, user interface 1100 is provided by an incident resolution service such as incident resolution service 121 of FIG. 1 and/or incident resolution service 200 of FIG. 2. In some embodiments, user interface 1100 is accessed via network clients such as clients 101 and/or 103 of FIG. 1 and is used to manage incidents related to devices such as the devices of customer network environment 111 of FIG. 1 using the processes of FIGS. 4-7.

In various embodiments, the provided root cause analysis workspace associated with user interface 1100 is provided from and/or within an incident resolution workspace. For example, incident identifier 1101 shows an identifier for the incident used to initiate the root cause analysis. In the example shown, incident identifier 1101 matches incident identifier 901 of FIG. 9 and incident identifier 1001 of FIG. 10 since the incident of FIGS. 9 and 10 is being analyzed in FIG. 11. Root cause analysis selection label 1103 is an interactive label that allows the user to switch between root cause analysis and incident resolution and consequently between the root cause analysis workflow of user interface 1100 and the corresponding incident resolution workflow associated with user interfaces 900 of FIGS. 9 and 1000 of FIG. 10.

In various embodiments, user interface 1100 provides details and actions for guiding the user through the root cause analysis of an incident. For example, selecting between “previous” and “current” selection choices allows the user to select between the current analysis and past root cause analyses performed. As shown in the example, root cause analysis description section 1105 includes description details of the root cause analysis including a list of individuals (and/or groups) assigned to the root cause analysis and their roles, details on how the incident arose and/or was detected, the opening date of the incident, and the close date of the incident, among other description information. Root cause analysis timeline section 1107 displays a timeline associated with the incident and/or root cause analysis and provides the option to display the events using a visual chart format or a table format. In the example shown, the different icons on the timeline can correspond to a successful remediation action (shown with a checkmark icon), the resolution of an incident (shown with a smiley face icon), and the request for a root cause analysis (shown with a question mark icon).

In various embodiments, root cause analysis details section 1109 displays analysis details including possible factors, causes, and fixes. These details can be automatically identified and suggested by the incident resolution service and/or provided by a service member or another individual familiar with the incident. In the example shown, root cause analysis details section 1109 also displays background information and prompts related to how the incident happened, how it was missed, and how the system failed. In some embodiments, the user can manually enter/modify this information and/or it can be automatically populated based on a flow diagram of the incident. For example, root cause analysis details section 1109 includes root cause analysis flow diagraming view selection label 1111 (labeled “Cause and effect”) that allows the user to switch to a flow diagraming view for investigating the root cause of the incident using a cause and effect approach. In some embodiments, the cause and effect approach allows the user to build a visual flow diagram describing the incident using cause and effect elements. Once created, the flow diagram can be used to populate the information in root cause analysis details section 1109.

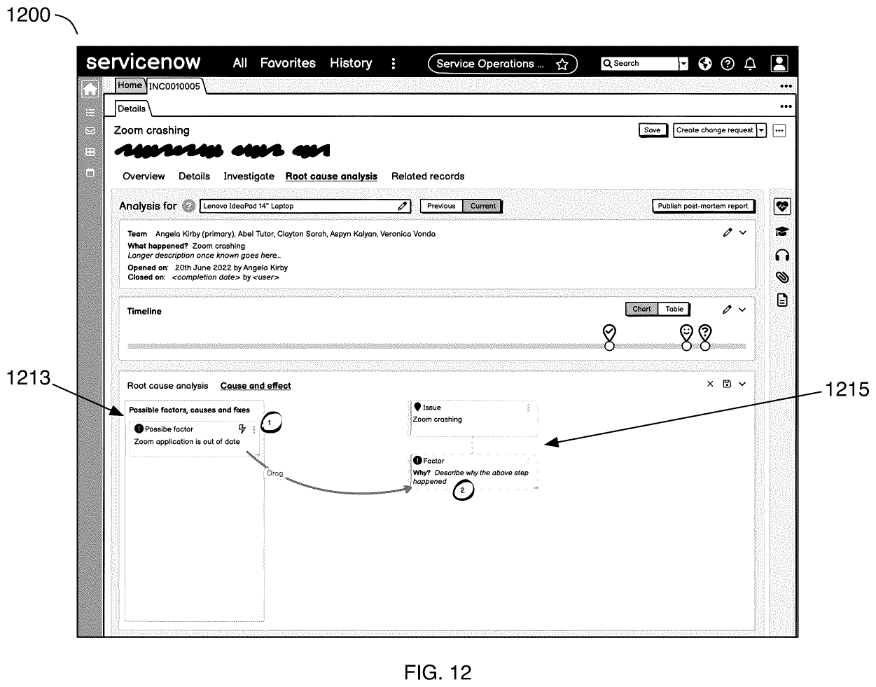

FIG. 12 is a diagram illustrating an embodiment of a flow diagraming user interface for performing root cause analysis using an incident resolution service. In various embodiments, user interface 1200 is part of a root cause analysis workspace and includes a flow diagraming interface for analyzing the root cause of an incident. For example, user interface 1200 can be used to create and modify a flow diagram of the incident using cause and effect elements. In various embodiments, the provided flow diagraming interface of user interface 1200 is an interactive flow diagraming interface that allows users to create a visual flow diagram of the incident using different element nodes. In some embodiments, user interface 1200 is invoked from user interface 1100 of FIG. 11 by selecting root cause analysis flow diagraming view selection label 1111 of FIG. 11. In the example shown, user interface 1200 includes a flow diagraming interface with labeled sections cause and effect elements section 1213 and root cause analysis flow diagram section 1215 to highlight the flow diagraming features of user interface 1200. In some embodiments, user interface 1200 is provided by an incident resolution service such as incident resolution service 121 of FIG. 1 and/or incident resolution service 200 of FIG. 2. In some embodiments, user interface 1200 is accessed via network clients such as clients 101 and/or 103 of FIG. 1 and is used to manage incidents related to devices such as the devices of customer network environment 111 of FIG. 1 using the processes of FIGS. 4-7.

In some embodiments, user interface 1200 and its corresponding workspace is used to generate a flow diagram of the incident. For example, elements from cause and effect elements section 1213 can be placed into root cause analysis flow diagram section 1215 to build a visual flow diagram describing the root cause of an incident. In various embodiments, cause and effect elements section 1213 displays candidate cause and effect elements for the incident and root cause analysis flow diagram section 1215 displays the current flow diagram associated with the incident. In some embodiments, the provided candidate cause and effect elements of cause and effect elements section 1213 are automatically identified and can be based on factors identified for the incident. In the example shown, cause and effect elements section 1213 includes one cause and effect element with the description “Zoom application is out of date.” The example element can be dragged (from the location labeled “1”) as a Factor node into root cause analysis flow diagram section 1215 and overlaid on top of the placeholder element with the description “Why? Describe why the above step happened” (at the location labeled “2”). The path of the placement movement is shown with the curved arrow and labeled “Drag.” In some embodiments, root cause analysis flow diagram section 1215 is prepopulated with a root element describing the incident issue. In the example shown, the root node is an Issue node with the description “Zoom crashing.”

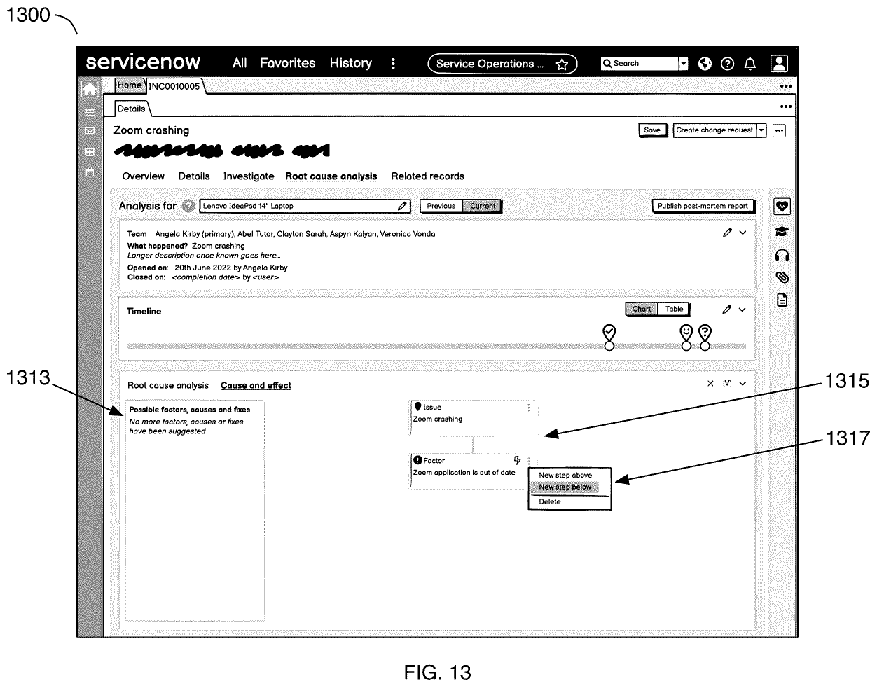

FIG. 13 is a diagram illustrating an embodiment of a flow diagraming user interface for performing root cause analysis using an incident resolution service. In various embodiments, user interface 1300 is part of a root cause analysis workspace and includes a flow diagraming interface for analyzing the root cause of an incident. For example, user interface 1300 can be used to create and modify a flow diagram of the incident and demonstrates the functionality of adding and deleting steps to the flow diagram. In various embodiments, the provided flow diagraming interface of user interface 1300 is an interactive flow diagraming interface that allows users to create a visual flow diagram of the incident by modifying the nodes of the flow diagram. In the example shown, user interface 1300 includes a flow diagraming interface with labeled sections cause and effect elements section 1313, root cause analysis flow diagram section 1315, and node modification dialog 1317 to highlight the flow diagraming features of user interface 1300.

In some embodiments, user interface 1300 corresponds to the state of the user interface as a new step is about to be added to the flow diagram. User interface 1300 is a progression in the root cause analysis workflow from user interface 1200 of FIG. 12, cause and effect elements section 1313 is a progression of cause and effect elements section 1213 of FIG. 12, and root cause analysis flow diagram section 1315 is a progression of root cause analysis flow diagram section 1215 of FIG. 12 as a new step is about to be added to the flow diagram. For example, cause and effect elements section 1313 contains no factors since the previously suggested factor has been added to the flow diagram of root cause analysis flow diagram section 1315.

In some embodiments, user interface 1300 is provided by an incident resolution service such as incident resolution service 121 of FIG. 1 and/or incident resolution service 200 of FIG. 2. In some embodiments, user interface 1300 is accessed via network clients such as clients 101 and/or 103 of FIG. 1 and is used to manage incidents related to devices such as the devices of customer network environment 111 of FIG. 1 using the processes of FIGS. 4-7.

In some embodiments, the flow diagram nodes and their relationship to other nodes can modified. For example, by selecting the details icon (shown with three vertical dots) of the Factor node in root cause analysis flow diagram section 1315, node modification dialog 1317 is provided as part of user interface 1300 and within root cause analysis flow diagram section 1315. Node modification dialog 1317 provides an interactive user interface view to add a new step (or node) to the flow diagram either above or below the selected node and to delete the selected node. In various embodiments, a user can add, modify, and delete nodes until the flow diagram visually traces the incident to its root cause.

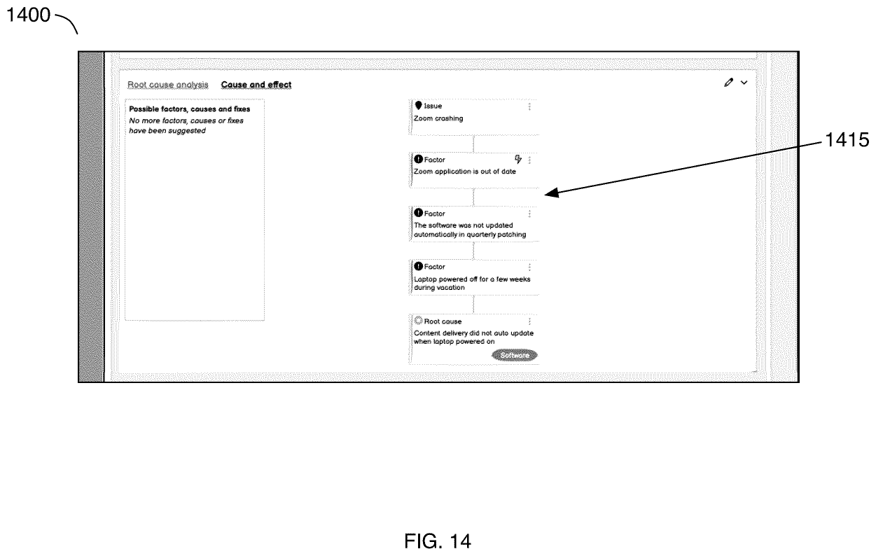

FIG. 14 is a diagram illustrating an embodiment of a flow diagraming user interface for performing root cause analysis using an incident resolution service. In various embodiments, user interface 1400 is part of a root cause analysis workspace and includes a flow diagraming interface for analyzing the root cause of an incident. For example, user interface 1400 can be used to create and modify a flow diagram of the incident and demonstrates the creation of a completed flow diagram. In various embodiments, the provided flow diagraming interface of user interface 1400 is an interactive flow diagraming interface that allows users to modify and save a created visual flow diagram of the incident. In the example shown, user interface 1400 includes a flow diagraming interface with labeled section root cause analysis flow diagram section 1415 to highlight the flow diagraming features of user interface 1400.

In some embodiments, user interface 1400 corresponds to the state of the user interface once the flow diagram is complete and has been saved. User interface 1400 is a progression in the creation of a flow diagram as part of the root cause analysis workflow from user interface 1300 of FIG. 13 (and before that user interface 1200 of FIG. 12), and root cause analysis flow diagram section 1415 displays the progression of the flow diagram of root cause analysis flow diagram section 1315 of FIG. 13 (and before that root cause analysis flow diagram section 1215 of FIG. 12). In some embodiments, user interface 1400 is provided by an incident resolution service such as incident resolution service 121 of FIG. 1 and/or incident resolution service 200 of FIG. 2. In some embodiments, user interface 1400 is accessed via network clients such as clients 101 and/or 103 of FIG. 1 and is used to manage incidents related to devices such as the devices of customer network environment 111 of FIG. 1 using the processes of FIGS. 4-7.

In various embodiments, once the flow diagram is completed, the flow diagram can be saved and later modified. In the example shown, the flow diagram of root cause analysis flow diagram section 1415 includes an Issue node, three Factor nodes, and a Root cause node. The root cause node includes the description “Content delivery did not auto update when laptop powered on.” The five nodes are linked and visually describe the analysis to determine the root cause for the incident. In some embodiments, the flow diagram can be automatically converted into root cause analysis results that utilize a different format, such as a tabular summary. For example, the “Root cause analysis” selection label can be selected to reveal a root cause analysis details section with root cause analysis details automatically generated from the completed flow diagram shown in root cause analysis flow diagram section 1415.

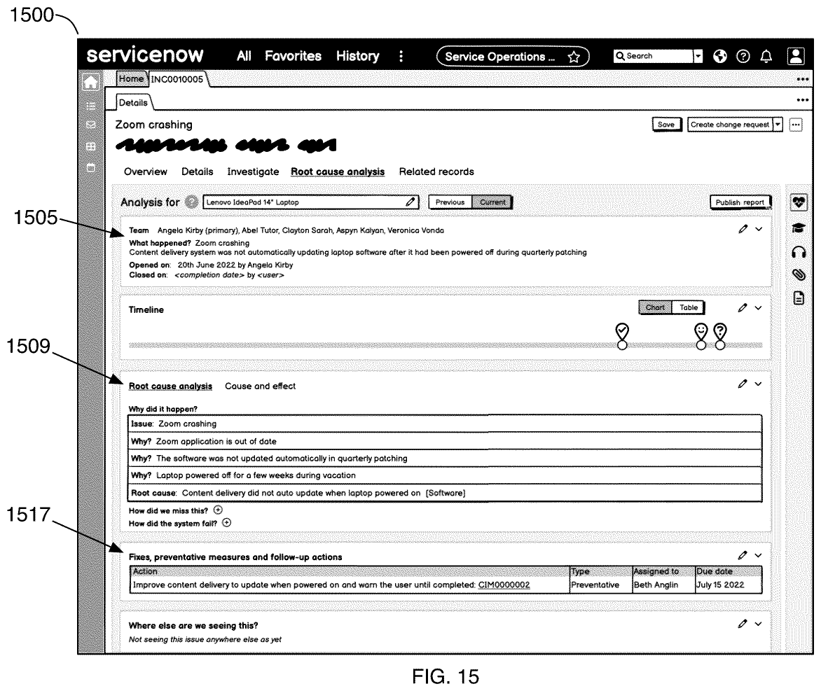

FIG. 15 is a diagram illustrating an embodiment of a user interface for performing root cause analysis using an incident resolution service. In various embodiments, user interface 1500 is part of a root cause analysis workspace for analyzing the root cause of an incident. For example, user interface 1500 can be used to publish a completed root cause analysis for an incident. In various embodiments, the provided user interface 1500 is an interactive user interface that allows users to save and share completed root cause analysis results. In the example shown, user interface 1500 includes labeled sections root cause analysis description section 1505, root cause analysis details section 1509, and root cause actions selection 1517 to highlight certain features of user interface 1500 including the display of additional details and analysis results for a completed root cause analysis.

In some embodiments, user interface 1500 corresponds to the state of the root cause analysis workspace once the corresponding flow diagram for the incident (as shown in FIG. 14) is complete and has been analyzed to generate root cause analysis results. User interface 1500 is a progression of the root cause analysis workflow from user interface 1400 of FIG. 14, and root cause analysis description section 1505, root cause analysis details section 1509, and root cause actions selection 1517 include additional information of the incident to reflect the completed root cause analysis. For example, root cause analysis description section 1505 corresponds to root cause analysis description section 1105 of FIG. 11 and root cause analysis details section 1509 corresponds to root cause analysis details section 1109 of FIG. 11 with updated details from the completed root cause analysis. In prior stages of the workflow, the corresponding section to root cause actions selection 1517 included no actions (as seen in FIG. 11).

In some embodiments, user interface 1500 is provided by an incident resolution service such as incident resolution service 121 of FIG. 1 and/or incident resolution service 200 of FIG. 2. In some embodiments, user interface 1500 is accessed via network clients such as clients 101 and/or 103 of FIG. 1 and is used to manage incidents related to devices such as the devices of customer network environment 111 of FIG. 1 using the processes of FIGS. 4-7.

In various embodiments, sections of user interface 1500 are updated with root cause analysis details corresponding to the completion of the root cause analysis. For example, root cause analysis description section 1505 is updated to describe the events of the incident (e.g., the “What happened?” subsection). This section can be automatically updated and/or updated by one or more of the listed root cause analysis team members. Further, when the analysis is deemed completed, the root cause analysis results can be published and/or shared. For example, a “Publish report” button allows users to publish the root cause analysis results as a report. In some embodiments, the report is provided to others via the incident resolution service. For example, the report can be searched for and viewed based on specifics of the report, such as via a keyword search. In some embodiments, the publish functionality is utilized as part of a sign-off step of the workflow that may require the analysis to first be approved before the incident's root cause can be finalized.

In some embodiments, the root cause analysis results include results automatically generated from a root cause analysis flow diagram. For example, root cause analysis details section 1509 includes a tabular view describing the incident with subsections for an issue description (i.e., the “Issue” subsection), what factors caused the incident (i.e., the “Why?” subsections), and a root cause explanation (i.e., the “Root cause” subsection). In various embodiments, the tabular view is automatically converted from the nodes of a corresponding flow diagram of the incident that is created with automatically identified cause and effect elements of the incident.

In some embodiments, the root cause analysis results include determined actions to apply now that the analysis is complete. For example, root cause actions selection 1517 includes fixes, preventative measures, and follow-up actions to apply to the incident. Other actions and types of actions can be appropriate as well. The actions can be described with a category type (such as fix, preventative, follow-up, or another category type) and they can be assigned to a responsible party with a due date. In some embodiments, the actions are automatically populated, for example, based on responsibilities assigned to different parties, based on past actions, and/or based on another action configuration or metric.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
providing a user interface to manage an information technology incident;
identifying one or more candidate factors of the incident or tasks related to the incident;
receiving a request to perform a root cause analysis associated with the incident; and
in response to receiving the request, providing at least one of the one or more candidate factors as a cause and effect element of the root cause analysis via the user interface.

2. The method of claim 1, wherein the user interface includes a flow diagram interface.

3. The method of claim 2, further comprising providing a visual flow diagram of the incident using the flow diagram interface.

4. The method of claim 3, wherein the visual flow diagram includes the cause and effect element of the root cause analysis.

5. The method of claim 3, wherein the visual flow diagram is modified by a drag action to place the cause and effect element of the root cause analysis as a node of the visual flow diagram.

6. The method of claim 3, wherein the visual flow diagram includes one or more connected nodes, and wherein each of the one or more connected nodes has a node type.

7. The method of claim 6, wherein the node type is an issue type, a factor type, or a root cause type, and wherein the cause and effect element of the root cause analysis corresponds to the factor type.

8. The method of claim 1, further comprising identifying one or more collaborators associated with the information technology incident.

9. The method of claim 8, further comprising providing the identified one or more collaborators with access to the user interface to manage the information technology incident.

10. The method of claim 1, wherein the user interface is a collaborative user interface accessible by two or more collaborators.

11. The method of claim 1, further comprising providing a timeline of the information technology incident.

12. A system comprising:
one or more processors; and
a memory coupled to the one or more processors, wherein the memory is configured to provide the one or more processors with instructions which when executed cause the one or more processors to:
provide a user interface to manage an information technology incident;
identify one or more candidate factors of the incident or tasks related to the incident;
receive a request to perform a root cause analysis associated with the incident; and
in response to receiving the request, provide at least one of the one or more candidate factors as a cause and effect element of the root cause analysis via the user interface.

13. The system of claim 12, wherein the user interface includes a flow diagram interface.

14. The system of claim 13, wherein the memory is further configured to provide the one or more processors with instructions which when executed cause the one or more processors to provide a visual flow diagram of the incident using the flow diagram interface.

15. The system of claim 14, wherein the visual flow diagram includes the cause and effect element of the root cause analysis.

16. The system of claim 14, wherein the visual flow diagram is modified by a drag action to place the cause and effect element of the root cause analysis as a node of the visual flow diagram.

17. The system of claim 14, wherein the visual flow diagram includes one or more connected nodes, and wherein each of the one or more connected nodes has a node type.

18. The system of claim 17, wherein the node type is an issue type, a factor type, or a root cause type, and wherein the cause and effect element of the root cause analysis corresponds to the factor type.

19. The system of claim 12, wherein the user interface is a collaborative user interface accessible by two or more collaborators.

20. A computer program product, the computer program product being embodied in a non-transitory computer readable storage medium and comprising computer instructions for:
providing a user interface to manage an information technology incident;
identifying one or more candidate factors of the incident or tasks related to the incident;
receiving a request to perform a root cause analysis associated with the incident; and
in response to receiving the request, providing at least one of the one or more candidate factors as a cause and effect element of the root cause analysis via the user interface.
